(19) United States
(12) Patent Application Publication
(10) Pub. No.: US 2005/0223180 A1
(43) Pub. Date: Oct. 6, 2005

(54) Accelerating the execution of I/O operations in a storage system

(76) Inventor: Philip Derbeko, Beer-Sheva (IL)

Correspondence Address: KATTEN MUCHIN ROSENMAN LLP, 575 MADISON AVENUE, NEW YORK, NY, 10022-2585, US

(21) Appl. No.: 10/813,757

(22) Filed: Mar. 31, 2004

(51) Int. Cl. G06F 12/16

(52) U.S. Cl. 711/162

(57) ABSTRACT

An apparatus and method for providing a storage system snapshot copy while allowing the execution of I/O operations without latency. A host request to write a data chunk to a production volume is served by writing the new data chunk to a journal, and upon writing, a response message is sent to the host signaling the end of the execution. The method thereafter performs off-line copying of the original data chunk from a production volume to a snapshot volume, and writes the new data chunk to the production volume.

### TECHNICAL FIELD

The present invention generally relates to storage system, and particularly, to an efficient method for creating a snapshot copy of a storage system.

### BACKGROUND OF THE INVENTION

As storage systems continue to provide increasing storage capacities to meet user demands, the demand for data backup and for enhanced reliability are also increasing. Various storage device configurations are commonly applied to accomplish the demands for higher storage capacity while maintaining or enhancing reliability of the storage systems.

Backup and snapshot are two techniques for increasing data reliability in storage systems. A snapshot is a copy image of a file or a disk at a certain point in time. A file or the whole disk is copied, at regular time intervals, into the same storage device, or a different storage device, to create the snapshot. In case that data has been lost or corrupted, data is recovered by restoring the data in the snapshot copy created immediately before the occurrence of the fault. Snapshot copies of a data set, such as files, are used for a variety of data processing and storage management functions such as storage backup, transaction processing, and software debugging. A backup may be referred to as a copy of the snapshot saved and stored on a different storage device (e.g., a tape drive).

In the related art, there are several techniques for making a snapshot copy. One technique is to respond to a snapshot copy request by invoking a task that copies data from a storage device that holds production data (i.e., a production disk) to a storage device that holds a snapshot copy (i.e., a snapshot disk). During the creation of a snapshot copy, a host cannot write new data to the production disk until its original contents have been entirely copied to the snapshot disk.

Another technique of making a snapshot copy is allocating storage to modified versions of data and holding the original versions of the data as production data. If a host requests to write new data to a production disk after a snapshot was created, the new data is written to a snapshot disk. This technique is known in the art as the “save changes” approach.

Yet, another technique of producing a snapshot copy is to write new data to a storage production disk after saving the original data in a snapshot disk that contains the snapshot copy. This is done, only if the requested write operation is the first write to a production disk since the last time a snapshot copy was created. This technique is known in the art as the “copy old on write” approach and is further disclosed in U.S. Pat. Nos. 6,182,198 and 6,434,681.

The “save changes” and the “copy old on write” approaches maintain a snapshot copy of production data, while a host may continue to access the production data, i.e., to perform I/O operations on the production disk. However, a shortcoming of these techniques is that the I/O operations are performed with substantial latency with respect to the initiation of the operation. For example, in order to write a data chunk to a production disk (using the “copy old on write” approach) the following steps have to take place:
a) checking in a lookup table whether a production disk has been modified;
b) reading an original data chunk from the production disk;
c) writing an original data chunk to an allocated storage in a snapshot disk;
d) writing the new data chunk to the production disk; and,
e) updating the lookup table.

The lookup table contains the status (i.e., modified or unmodified) of each data chunk written to a production disk or a snapshot disk. The size of a lookup table is linearly proportionate to the number of data blocks in a disk. In a typical storage system the size of such a lookup table can be relatively high and therefore it is usually kept on a disk (i.e., not in the host local memory).

As can be understood from the above example, a write request initiated by a host requires at least three disk accesses and at most five disk accesses (i.e., if the lookup table is kept on the disk). Hence, the latency to complete the execution of a write operation is significantly long. Furthermore, during this time period the host is idled. The latency may be even longer if the snapshot and the production disks are virtual volumes. A virtual volume is composed of on one or more physical disks, and thus data can be written to multiple disks located on different storage devices.

Therefore, in the view of the shortcomings of the approaches known in the related art, it would be advantageous to provide a method for providing a snapshot copy while executing I/O operations without latency.

### SUMMARY OF THE INVENTION

A method and apparatus for enabling the execution of at least an I/O operation while providing a snapshot copy of a storage system. The method and apparatus includes: a) performing on-line at least a primary task of an I/O operation, wherein the primary task is performed using a journal; b) generating a response message ending the execution of the I/O operation; and, c) performing off-line secondary tasks of the I/O operation.

Also described is a computer-readable medium having stored thereon computer executable code enabling the execution of at least an I/O operation while providing a snapshot copy of a storage system. The executable code for performing the steps of: a) performing on-line at least a primary task of an I/O operation, wherein the primary task is performed using a journal; b) generating a response message ending the execution of the I/O operation; and, c) performing off-line secondary tasks of said I/O operation.

In an example embodiment, a primary task includes writing a data chunk included in the write request into the journal; and, saving a destination address designated in the write request in a changes table. In another example embodiment secondary tasks include checking if the data chunk residing in the snapshot storage element was modified since a last time the snapshot copy was created; copying the data chunk from a location in the production storage element to the snapshot storage element and further copying the data chunk from the journal to a location in the production storage element, if the data chunk has not been modified; and, copying the data chunk from the journal to the production storage element, if the data chunk has been modified

### BRIEF DESCRIPTION OF THE DRAWINGS

FIG. 1—is an exemplary diagram of a simple storage system illustrating the principles of the present invention;

FIG. 2—is an exemplary diagram of a storage area network illustrating the principles of the present invention;

FIG. 3—is an exemplary flowchart describing the method for executing a write operation in accordance with the present invention;

FIG. 4—is an exemplary flowchart describing the method for executing a read operation in accordance with the present invention.

### DETAILED DESCRIPTION OF THE INVENTION

Disclosed is an efficient method for providing a snapshot copy of a storage system. According to the disclosed method a snapshot copy is created while allowing the execution of I/O operations with minimal latency. This is achieved by leveraging the attributes inherent in a journal to provide enhanced on-line snapshot performance.

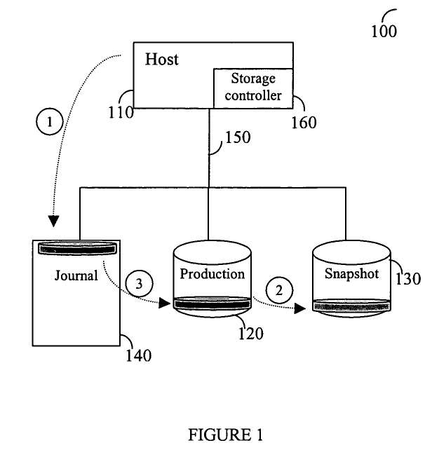

Referring to FIG. 1, an exemplary and non-limiting diagram of a simple storage system 100 is shown. System 100 comprises a host computer 110 a production storage device 120, a snapshot storage device 130, and a journal 140 connected to host computer 110 through a connection 150. Each of storage devices 120 and 130 may be, but are not limited to, a disk, a tape drive, an optical drive, and a redundant array of independent disks (RAID). Journal 140 may be comprised of one or more non-volatile random access memory (NVRAM) units. In one implementation journal 140 may be a storage device, e.g., a disk. The storage elements, whether NVRAM or disk-based, are controlled by a storage controller 160. Storage controller 160 is adapted to operate in accordance with the disclosed invention. Connection 150 forms a direct connection between storage controller 160 and the storage elements. Connection 150 may be, but is not limited to, a small computer system interface (SCSI) connection, a fiber channel (FC) connection, and the likes. Snapshot device 130 includes snapshot copies of the contents of production device 120 and further includes a lookup table. The lookup table indicates the status of each data chunk that was written to production device 120, i.e., if the data chunk has been modified since the last time that a snapshot copy was taken.

Journal 140 may be considered as a first-in first-out (FIFO) queue where the first inserted record is the first to be removed from journal 140. Journaling is used intensively in database systems and in file systems. In such systems the journaling logs any transactions or file system operations. The present invention records in journal 140 the I/O operations as they occur. Specifically, journal 140 saves write operations and data associated with these operations. Journal 140 further includes a changes table that will be referred hereinafter as the “JOR_Table”. The JOR_Table comprises of a plurality of entries, each entry containing the actual address of a data chunk saved in journal 140 and a pointer pointing to the location of the data chunk in journal 140. The JOR_Table may be saved in the local memory of host 110. It should be noted the size of the JOR_Table is significantly smaller than the size of the lookup table. Specifically, the size of the JOR_Table is linearly proportionate to the number of changes made to the production storage device 120.

The fast execution of 1/0 operations while maintaining a snapshot copy is achieved by having host 110 to communicate directly with journal 140. Specifically, host 110 reads modified data and writes new data from and to journal 140. Once the requested data is read or written from or to journal 140, a message, signaling the end of the execution of the 1/0 operation, is sent to host 110. This message releases host 110 to execute other tasks, including but not limited to related tasks. Storage controller 160 performs off-line updates of snapshot device 130 and production device 120 with the outcome of the executed operation, namely without the intervention of host 110. For example, in order to write a data chunk, storage system 100 responds to a write request initiated by host 110 by inserting the data chunk to be written together with the destination address into journal 140, and upon inserting this content to journal 140, an ending message is sent back to host 110. Subsequently, original data that resides in production device 120, at a location designated by the destination address, is copied to snapshot device 130, and thereafter the new data chunk is copied from journal 140 to production device 120.

It should be realized by one who is skilled in the art that host 110 is idled only for the time period required to write the data chunk to journal 140. Other tasks involved with disk accesses, i.e., reading and writing to production and snapshot devices 120 and 130 are performed off-line, and thus do not impact the performance of host 110.

In one embodiment of the present invention the storage elements may be virtual volumes. A virtual volume can be anywhere on one or more physical storage devices. Each virtual volume may consist of one or more virtual volumes or/and one or more logical units (LUs), each identified by a logical unit number (LUN). Each LU, and hence each virtual volume, is generally comprised of one or more contiguous partitions of storage space on a physical device. Thus, a virtual volume may occupy a whole storage device, a part of a single storage device, or parts of multiple storage devices. The physical storage devices, the LUs and their exact locations, are transparent to the user. As mentioned above performing 1/0 operations on virtual volumes while maintaining a snapshot copy may necessitate accessing multiple different physical devices, and thus the latency of such operations may be significantly increased. The method disclosed above is adapted to handle such virtual volumes as explained in more detail below.

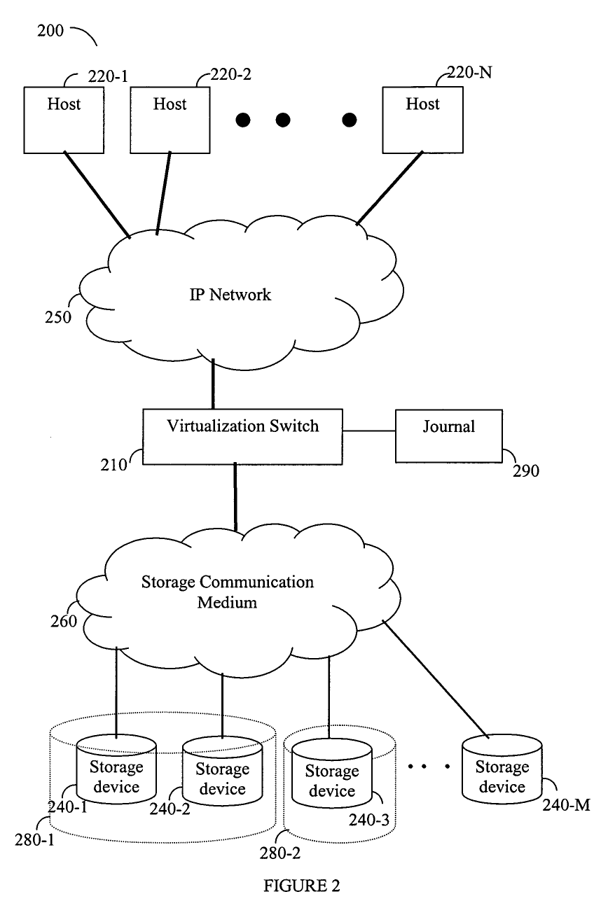

Referring to FIG. 2, an exemplary diagram of a storage area network (SAN) 200 including a virtualization switch 210 is shown. Virtualization switch 210 is utilized to provide a snapshot copy while allowing the execution of I/O operations, such as write and read from a production volume with minimal latency. SAN 200 includes a plurality of hosts 220 connected to an IP network 250 through, for example, a local area network (LAN) or a wide area network (WAN). Hosts 220 communicate with virtualization switch 210 through IP network 250. Virtualization switch 210 is connected to a plurality of storage devices 240 though a storage communication medium 260. Storage communication medium 260 may be, but is not limited to, a fabric of FC switches, a SCSI bus, and the likes. Virtualization switch 210 is further disclosed in U.S. patent application Ser. No. 10/694,115 entitled “A Virtualization Switch and Method for Performing Virtualization in the Data-Path” assigned to common assignee and which is hereby incorporated for all that it contains.

Virtualization switch 210 operates within SAN 200 and performs all virtualization tasks, which essentially include the mapping of a virtual address space to an address space of one or more physical storage devices. SAN 200 is configured to maintain a production volume 280-1, a snapshot volume 280-2, and a journal 290. Production volume 280-1 is composed of storage devices 240-1 and 240-2 and snapshot volume 280-2 is composed of one or more storage devices, for example, storage device 240-3. Snapshot volume 280-2 holds the snapshot copies of production data saved in production volume 280-1 and further holds a lookup table including the status (i.e., modified or unmodified) of each data chunk written to production volume 280-1. Journal 290, in one example embodiment, is a NVRAM connected to an uninterruptible power supply (not shown) for the purpose of backup in the case of power failure. The JOR_Table is saved in a local memory of virtualization switch 210.

To allow the execution of I/O operations with minimal latency, virtualization switch 210 writes data chunks sent from hosts 220 to journal 290, and modified data requested by hosts 220 is retrieved directly from journal 290. As a non-limiting example, if a host 220 desires to write a data chunk including two data blocks to production volume 280-1, then virtualization switch 210 receives a write command, e.g., a SCSI command that includes at least the data chuck and the virtual address to save the data chunk. Upon the receiving of a write command, virtualization switch 210 saves the data chunk and the destination virtual address in journal 290, updates the JOR_Table, and sends, to an initiator host 220, a response command that notifies the end of the SCSI command. Subsequently, virtualization switch 210 modifies the content of production volume 280-1 and snapshot volume 280-2 with the content of the new data chunk.

The latency of this write operation from a host's perspective is only the time it takes to write the data chunk to journal 290 which is equivalent to the time needed to write the data in the production volume without maintaining a snapshot copy. This time is significantly shorter than the time needed for prior art solutions to execute an equivalent operation. For instance, if a first data block of the data chunk is targeted to storage device 240-1 and the second data block of the data chunk is targeted to storage device 240-2, then the time it takes to complete this operation is at least the time required to complete the following: 1) reading a first original data block from storage device 240-1; 2) writing the first original data block to storage device 240-3 (i.e., to snapshot volume 280-2); 3) reading a second original data block from storage device 240-2; 4) writing the second old data block to storage device 240-3; 5) writing the first new data block to storage 240-1; and 6) writing the second new data block to storage 240-2. Hence, at least six separate disk accesses are required. In contrast, according to the disclosed invention only a single memory access operation is required, from the host's perspective, freeing it to perform other tasks. Other tasks requiring disk accesses are preformed off-line by virtualization switch 210.

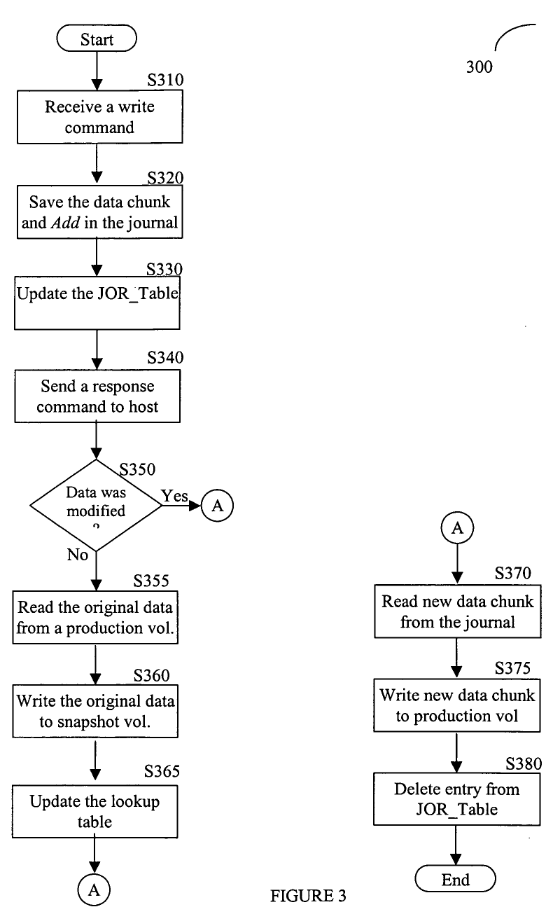

Referring to FIG. 3, an exemplary and non-limiting flowchart 300 describing the method for executing a write operation in accordance with an example embodiment of the present invention is shown. The write operation writes a data chunk to a production volume. The method will be described hereafter with reference to the storage system shown in FIG. 2. However, this is only for exemplary purposes and should not be viewed as limiting the scope of the disclosed invention.

At step S310, a new write command sent from an initiator host 220 is received at virtualization switch 210. Virtualization switch 210 may process the received command to determine, for example, the type of the command, its validity, the target volume, and so on. At step S320, the data chunk and the virtual address designated in the command are saved in journal 290. The virtual address is a logic location in a target volume, i.e., production volume 280-1. At step S330, the JOR_Table is updated by adding an entry including the virtual address and setting the pointer to point to the location of the data chunk in journal 290. At step S340, a response command, signaling the end of the write command, is sent to the initiator host. At step S350, a check is performed to determine if the data chunk in the snapshot volume 280-2 has been modified since the last time a snapshot copy was created. This is performed by checking the status of the data chunk in the lookup table of snapshot volume 280-2. If the data chunk was modified, the execution continues with step S370 where the data chunk is read from its location in journal 290 and written, at step S375, to its appropriate location in the physical storage device or devices of the production volume 280-1, e.g., storage devices 240-1 and 240-2. For that purpose the virtual address is converted to a list of physical addresses of the actual location in the physical storage devices. At step S380, the entry associated with the data chunk is deleted from the JOR_Table. If step S350 yields a negative answer, then the execution continues with step S355 where the original data chunk is read from production volume 280-1. This is performed by converting the virtual address to a physical address (or addresses) and retrieving the original data chunk residing in the physical address. At step S360, the original data chunk is written to a physical storage location allocated in snapshot volume 280-2. At step S365, the status indication of the data chunk in the lookup table is set to ‘modified’ and the execution proceeds with steps S370, S375, and S380 where the new data chunk is copied from journal 290 to production volume. It should be noted that steps S320, S330 and S340 are executed on-line, while steps S350 through S380 are executed off-line.

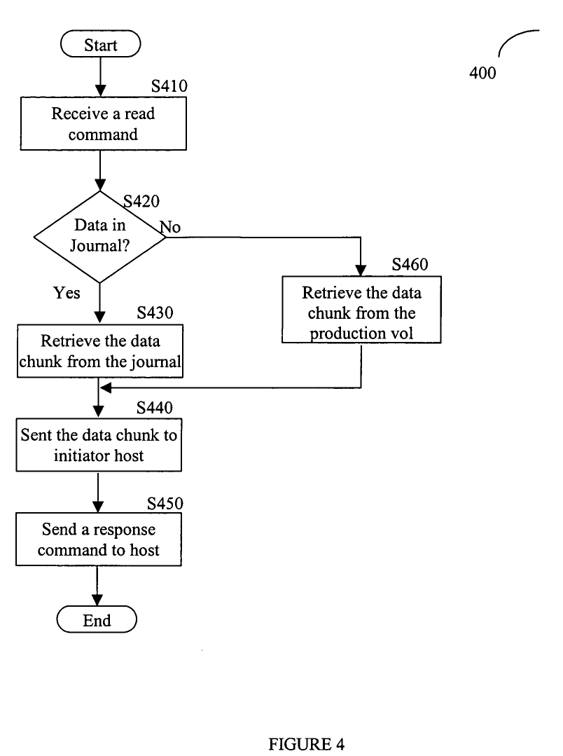

Referring to FIG. 4, an exemplary and non-limiting flowchart 400, describing the method for executing a read operation in accordance with the present invention, is shown. The read operation reads data from a production volume. The method will be described hereafter with reference to the storage system shown in FIG. 2. However, this is only for exemplary purposes and should not be viewed as limiting the scope of the disclosed invention. At step S410, a new read SCSI command sent from an initiator host 220 is received at virtualization switch 210. Virtualization switch 210 may process the incoming command to determine, for example, the type of the command, its validity, the target volume, and so on. At step S420, a check is performed to determine if the data chunk requested to be read resides in journal 290. This is preformed by searching for an entry in the JOR_Table that includes the virtual address designated in the received read command. If such entry was found then, at step S430, the requested data chunk is retrieved from journal 290 and subsequently, at step S440, the data chunk is sent to the initiator host 220. Virtualization switch 210 accesses the requested data chunk through a pointer that points to the location of the data chunk in journal 290. This pointer is part of a JOR_Table's entry associated with the requested data chunk. At step S450, a response command is sent to the initiator host ending the execution of the read command. If the requested data chunk does not reside in journal 290, then execution continues with step S460 where the data chunk is retrieved from production volume 280-1. This is performed by converting the logical address to a physical address (or addresses) of the actual location in storage devices 240-1 and 240-2 and then retrieving the data chunk from the actual location. The method proceeds with steps S440 and S450 where the data chunk together with a response command are sent to the initiator host.

The invention has now been described with reference to a specific embodiment where read and write operations are executed without latency. Other embodiments will be apparent to those of ordinary skill in the art. Specifically, the invention can be adapted to reduce the latency of any I/O operations that are performed in a substantial latency by performing some of the sub-tasks involved with such operations off-line.

1. A method for enabling the execution of at least an I/O operation while providing a snapshot copy of a storage system, said method comprises the steps of:
a) performing on-line at least a primary task of said I/O operation, wherein said primary task is performed using a journal;
b) generating a response message ending the execution of said I/O operation; and,
c) performing off-line secondary tasks of said I/O operation.

2. The method of claim 1, wherein said storage system includes at least: a host, a journal, a snapshot storage element, a production storage element.

3. The method of claim 2, wherein said snapshot storage element is at least one of: a virtual volume, a physical storage device.

4. The method of claim 2, wherein said production storage element is at least one of: a virtual volume, a physical storage device.

5. The method of claim 1, wherein said journal includes at least one non-volatile random access memory (NVRAM) unit.

6. The method of claim 1, wherein said I/O operation is a write request initiated by the host.

7. The method of claim 6, wherein said performing on-line at least a primary task further comprises the steps of:
a) writing a data chunk included in said write request into said journal; and,
b) saving a destination address designated in said write request in a changes table.

8. The method of claim 6, wherein said generating a response message further comprises the step of:
sending said response message to said host.

9. The method of claim 6, wherein said performing off-line secondary tasks further comprises the steps of:
a) checking if said data chunk residing in the snapshot storage element was modified since a last time said snapshot copy was created;
b) copying said data chunk from a location in the production storage element to said snapshot storage element and further copying said data chunk from said journal to a location in said production storage element, if said data chunk has not been modified; and,
c) copying said data chunk from said journal to said production storage element, if said data chunk has been modified.

10. The method of claim 9, wherein the location in said production storage element is determined by said destination address.

11. The method of claim 10, wherein said destination address is converted to a physical address if said production storage element is a virtual volume.

12. The method of claim 1, wherein said I/O operation is a read request initiated by the host computer.

13. The method of claim 12, wherein said performing on-line at least a primary task further comprises the steps of:
a) checking if a data chunk requested to be read resides in said journal; and,
b) retrieving said data chunk from said journal and further sending said data chunk to said host, if said data chunk resides in said journal.

14. The method of claim 13, wherein checking if said data chunk resides in said journal further comprises the step of:
checking whether the changes table includes an entry associated with said data chunk.

15. The method of claim 13, wherein said performing off-line secondary tasks further comprises the steps of:
a) retrieving said data chunk from the production storage element, if said data chunk does not reside in said journal; and,
b) sending said data chunk to said host.

16. The method of claim 15, wherein said data chunk is retrieved from a location designated by a source address included in said read request.

17. The method of claim 16, wherein said source address is converted to a physical address if said production storage element is a virtual volume.

18. A computer-readable medium having stored thereon computer executable code enabling the execution of at least an I/O operation while providing a snapshot copy of a storage system, said executable code for performing the steps of:
a) performing on-line at least a primary task of said I/O operation, wherein said primary task is performed using a journal;
b) generating a response message ending the execution of said I/O operation; and,
c) performing off-line secondary tasks of said I/O operation.

19. The computer executable code of claim 18, wherein said storage system comprises at least: a host, a journal, a snapshot storage element, a production storage element.

20. The computer executable code of claim 19, wherein said snapshot storage element is at least one of: a virtual volume, a physical storage device.

21. The computer executable code of claim 19, wherein said production storage element is at least one of: a virtual volume, a physical storage device

22. The computer executable code of claim 18, wherein said journal includes at least one non-volatile random access memory (NVRAM) unit.

23. The computer executable code of claim 18, wherein said I/O operation is a write request initiated by the host.

24. The computer executable code of claim 23, wherein said performing on-line at least a primary task further comprises the steps of:
a) writing a data chunk included in said write request into said journal; and,
b) saving a destination address designated in said write request in a changes table.

25. The computer executable code of claim 23, wherein said generating a response message further comprises the step of:
sending said response message to said host.

26. The computer executable code of claim 23, wherein said performing off-line secondary tasks further comprises the steps of:
a) checking if said data chunk resides in the snapshot storage element was modified since a last time said snapshot copy was created;
b) copying said data chunk from a location in the production storage element to said snapshot storage element and further copying said data chunk from said journal to a location in said production storage element, if said data chunk has not been modified; and,
c) copying said data chunk from said journal to said production storage element, if said data chunk has been modified.

27. The computer executable code of claim 26, wherein the location in said production storage element is determined by said destination address.

28. The computer executable code of claim 27, wherein said destination address is converted to a physical address if said production storage element is a virtual volume.

29. The computer executable code of claim 18, wherein said I/O operation is a read request by the host.

30. The computer executable code of claim 29, wherein said performing at least a primary task further comprises the steps of:
a) checking if a data chunk requested to be read resides in said journal; and,
b) retrieving said data chunk from said journal and further sending said data chunk to said host, if said data chunk resides in said journal.

31. The computer executable code of claim 30, wherein checking if said data chunk resides in said journal further includes:
checking whether the changes table includes an entry associated with said data chunk.

32. The computer executable code of claim 30, wherein said performing off-line secondary tasks further comprises the steps of:
a) retrieving said data chunk from the production storage element, if said data chunk does not reside in said journal; and,
b) sending said data chunk to said host.

33. The computer executable code of claim 32, wherein said data chunk is retrieved from a location designated by a source address included in said read request.

34. The computer executable code of claim 33, wherein said source address is converted to a physical address if said production storage element is a virtual volume.

35. An apparatus for execution of at least an I/O operation with minimal latency while providing a snapshot copy of a storage system, said apparatus comprising:
means for receiving said at least an I/O operation from a host;
means for performing on-line at least one primary task of said at least an I/O operation;
means for performing off-line at least a secondary task of said at least an I/O operation;
means for controlling a snapshot storage element;
means for controlling a production storage element; and, means for controlling a journal.

36. The apparatus of claim 35, wherein said snapshot storage element is at least one of: a virtual volume, a physical storage device.

37. The apparatus of claim 35, wherein said production storage element is at least one of: a virtual volume, a physical storage device.

38. The apparatus of claim 35, wherein said physical storage device comprises at least one of: tape drive, tape library, optical drive, disk, redundant array of independent disks (RAID).

39. The apparatus of claim 35, wherein said journal includes at least one non-volatile random access memory (NVRAM) unit.

40. The apparatus of claim 35, wherein said I/O operations comprise at least one of: write request, read request.

41. The apparatus of claim 35, wherein said primary task is performed on-line using said journal.

42. The apparatus of claim 35, wherein said apparatus is a storage controller.

43. The apparatus of claim 35, wherein said apparatus is a virtualization switch connected in a storage area network (SAN).

44. The apparatus of claim 35, wherein said I/O operation is a read request initiated by said host.

45. The apparatus of claim 44, wherein said performing said primary task further comprises the steps of:
a) checking if a data chunk requested to be read resides in said journal; and,
b) retrieving said data chunk from said journal and further sending said data chunk to said host, if said data chunk resides in said journal.

46. The apparatus of claim 45, wherein checking if said data chunk resides in said journal further comprises:
checking whether the changes table includes an entry associated with said data chunk.

47. The apparatus of claim 45, wherein said performing off-line secondary tasks further comprises the steps of:
a) retrieving said data chunk from the production storage element, if said data chunk does not reside in said journal; and,
b) sending said data chunk to said host.

48. The apparatus of claim 35, wherein said I/O operation is a write request initiated by said host.

49. The apparatus of claim 48, wherein said performing on-line at least a primary task further comprises the steps of:
a) writing a data chunk included in said write request into said journal;
b) saving a destination address designated in said write request in a changes table; and,
c) sending a response message to said host.

50. The apparatus of claim 48, wherein said performing off-line secondary tasks further comprises the steps of:
a) checking if said data chunk resides in the snapshot storage element was modified since a last time said snapshot copy was created;
b) copying said data chunk from a location in the production storage element to said snapshot storage element and further copying said data chunk from said journal to a location in said production storage element, if said data chunk has not been modified; and,
c) copying said data chunk from said journal to said production storage element, if said data chunk has been modified.
